(19) United States
(12) Patent Application Publication
(10) Pub. No.: US 2009/0127426 A1
(43) Pub. Date: May 21, 2009

(54) Storage holders for presses

(76) Inventors: Karen Shackelford, Victorville, CA (US); Donald L. Shackelford, JR., Victorville, CA (US)

Correspondence Address: JAMES RAY & ASSOCIATES, 2640 PITCAIRN ROAD, MONROEVILLE, PA, 15146, US

(21) Appl. No.: 12/157,999

(22) Filed: Jun. 16, 2008

Related U.S. Application Data
(60) Provisional application No. 61/004,041, filed on Nov. 21, 2007.

(51) Int. Cl. B25H 3/04

(52) U.S. Cl. 248/674

(57) ABSTRACT

An apparatus for storing various types of presses. The apparatus comprises a first elongated frame member having each of a first predetermined shape which includes a C shape. A second elongated frame member has each of a second predetermined shape which includes a reverse C shape. There is at least one bracket member, one end of the bracket member is engageable with and secured to a bottom portion of the first elongated frame member and a second end of the bracket member is engageable with and secured to a bottom portion of the second elongated frame member. The bracket member has a slot formed therethrough for adjustably connecting the second frame member with the first frame member. There is a first securing means for securing the first member to one end of the bracket member and the second frame member to a radially opposed end of the bracket member. A second securing means is used for securing the apparatus to one of a wall, an inside of a door, an underside of a cabinet and an underside of a counter top.

### CROSS REFERENCE TO RELATED APPLICATIONS

This application is closely related to and claims benefit from U.S. Provisional Application Ser. No. 61/004,041 filed Nov. 21, 2007.

### FIELD OF THE INVENTION

The present invention relates, in general, to storage holders, and, more particularly, the present invention relates to an under cabinet mounting arrangement that enables the homemaker to store presses such as a bacon press or a panini press out of the way yet handy to retrieve.

### BACKGROUND OF THE INVENTION

Many kitchen cooks use a press to create specialty sandwiches and to ensure that bacon does not curl. Bacon presses are placed on the top of such bacon as it cooks. There are also specialty presses that are used for decorative purposes. Presses come in various shapes and sizes and many are made of cast iron and, thus, are quite heavy. Keeping these presses in a drawer or cabinet can limit access when needed and without the press being readily available or in full view, a user may forget to use it or find it too troublesome to retrieve it. Further, keeping presses in cabinets or drawers uses up valuable storage space that can be better utilized with equipment or items that are more frequently used.

Thus, it would be advantageous if there were a simple and effective means of storing these presses out of the way and yet being readily available when wanted.

### SUMMARY OF THE INVENTION

In a first aspect the present invention provides an apparatus for storing various types of presses. The apparatus comprises a first elongated frame member having each of a first predetermined shape and a first predetermined length and formed of a first predetermined material, such first predetermined shape of the first frame member includes a C shape. A second elongated frame member has each of a second predetermined shape and a second predetermined length and is formed of a second predetermined material, such second predetermined shape of the second frame member includes a reverse C shape. There is at least one bracket member, one end of the at least one bracket member is engageable with and secured to a bottom portion of the first elongated frame member and a second end of the bracket member is engageable with and secured to a bottom portion of the second elongated frame member. The at least one bracket member has a slot formed therethrough for adjustably connecting the second elongated frame member with the first elongated frame member. There is a first securing means for securing the first member to one end of the at least one bracket member and the second frame member to a radially opposed end of the at least one bracket member. A second securing means is used for securing the apparatus to one of a wall member, an inside of a door, an underside of a cabinet and an underside of a counter top.

### OBJECTS OF THE INVENTION

It is, therefore, one of the primary objects of the present invention to provide a press holder that can be attached to any flat surface in a kitchen.

Another object of the present invention is to provide a press holder wherein the press is stored without losing any valuable storage space.

Still another object of the present invention is to provide a press holder that permits the user easy access to the press.

Yet another object of the present invention is to provide a press holder that can be attached to undersides of cabinets or counters or on unused walls of cabinets or even inside of cabinet doors.

In addition to the various objects and advantages of the invention which have been described in some specific detail above it should be noted that various other objects and advantages of the present invention will become more readily apparent to those persons who are skilled in the relevant art from the following more detailed description, particularly when such description is taken in conjunction with the appended claims.

### BRIEF DESCRIPTION OF THE DRAWINGS

FIG. 1 is a top perspective view of an apparatus for storing a press according to an embodiment of the invention.

FIG. 2 is a perspective view of the apparatus shown in FIG. 1 with a press positioned therein wherein the apparatus is placed on the inside of a cabinet door.

FIG. 3 is a perspective view of the apparatus shown in FIG. 1 with a press positioned therein wherein the apparatus is placed on the underside of cabinet or counter top.

FIG. 4 is a perspective view of the apparatus shown in FIG. 1 with a press positioned therein wherein the apparatus is placed on a wall surface.

FIG. 5 is a perspective view of three different apparatuses having different size presses stored therein showing the adjustment for the different size presses.

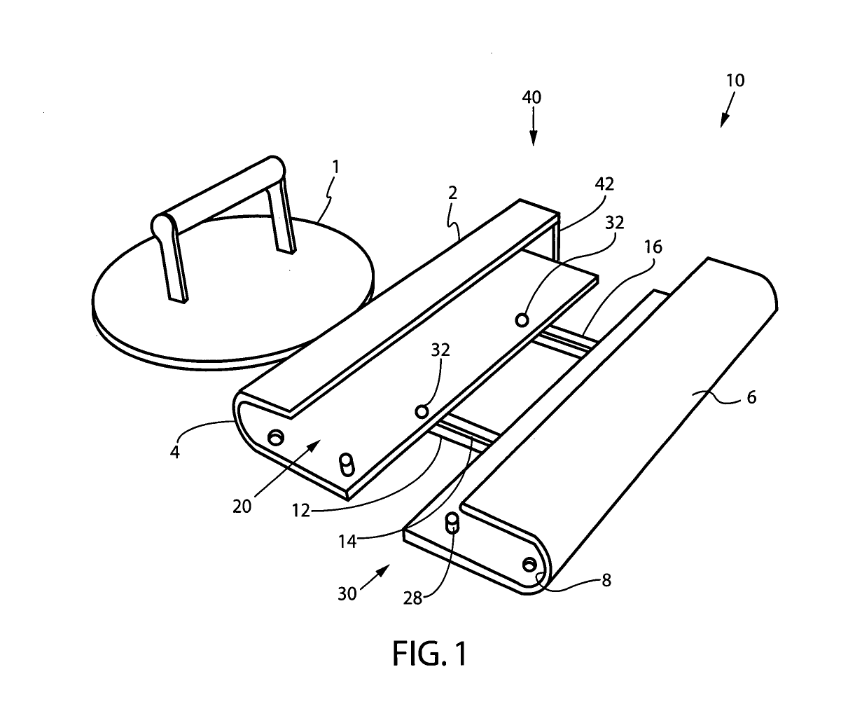

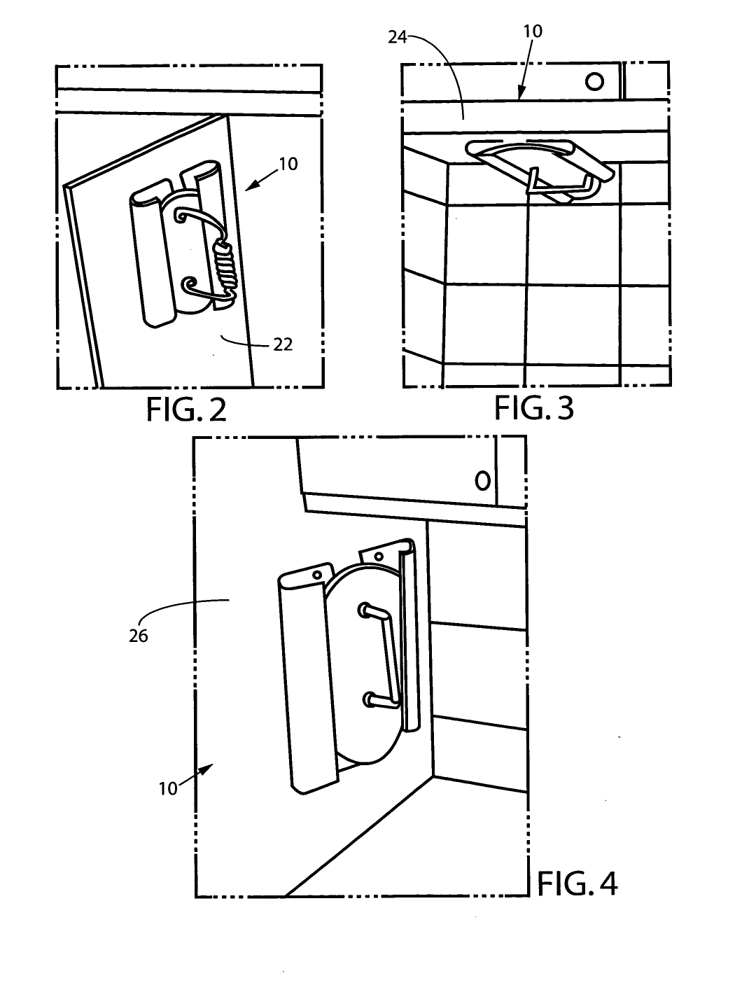

### BRIEF DESCRIPTION OF THE PRESENTLY PREFERRED AND VARIOUS ALTERNATIVE EMBODIMENTS OF THE INVENTION

Prior to proceeding with the more detailed description of the present invention it should be noted that, for the sake of clarity, identical components which have identical functions have been designated by identical reference numerals throughout the several views illustrated in the drawings.

In a first aspect the present invention provides an apparatus, generally designated 10, for storing various types of presses. The apparatus 10 comprises a first elongated frame member 2 which has each of a first predetermined shape and a first predetermined length and is formed of a first predetermined material, such first predetermined shape of the first frame member includes a C shape 4. A second elongated frame member 6 has each of a second predetermined shape and a second predetermined length and is formed of a second predetermined material, such second predetermined shape of the second frame member includes a reverse C shape 8. There is at least one bracket member 12, one end of the at least one bracket member 12 is engageable with and secured to a bottom portion of the first elongated frame member 2 and a second end of the bracket member 12 is engageable with and secured to a bottom portion of the second elongated frame member 6. The at least one bracket member 12 has a slot 14 formed therethrough for adjustably connecting the second elongated frame member 6 with the first elongated frame member 2. There is a first securing means, generally designated 20, for securing the first elongated member 2 to one end of the at least one bracket member 12 and the second frame member 6 to a radially opposed end of the at least one bracket member 12. A second securing means, generally designated 30, is used for securing the apparatus 10 to one of a wall member 26, an inside of a door 22, an underside of a cabinet 24 and an underside of a counter top 24.

The first securing means 20 for securing the first frame member 2 and the second frame member 6 to the at least one bracket member 12 includes nuts and bolts 32 and/or an adhesive material. The apparatus 10 includes two bracket members 12,16, a first one of the two bracket members 12 being disposed between a first end and a second end of each of the first elongated frame member 2 and the second elongated frame member 6 and the second one of the two bracket members 16 being disposed between the first one of the two bracket members 12 and the second end of each of the first elongated frame member 2 and the second elongated frame member 6.

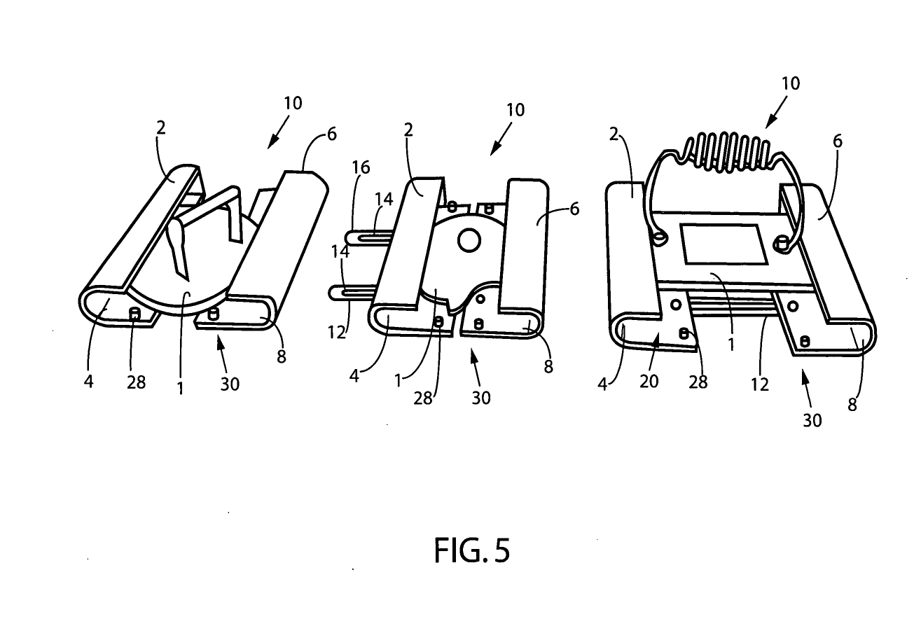

As seen in FIG. 5 the distance between the first elongated frame member 2 and the second elongated frame member 6 is adjustable so as to fit different sizes of such various types of presses 1. The presses 1 are secured between the first elongated frame member 2 and the second elongated frame member 6, the edges of such presses 1 are engageable with the C-shape 4 of the first elongated frame member 2 and the reverse C-shape 8 of the second elongated frame member 6.

The second securing means 30 for securing the apparatus 10 with at least one of a wall member 26, an inside of a door 22, an underside of a cabinet 24 or an underside of a counter top 24 includes one of screws 28 and an adhesive. It is presently preferred that such second securing means 30 is screws 28.

The apparatus 10 includes a means, generally designated 40, for preventing such presses 1 disposed in the apparatus 10 from falling out. Such means 40 for preventing such presses 1 disposed in the apparatus 10 from falling out includes a projection 42 disposed on one of a back end and a bottom end of at least one of the first elongated member 2 and the second elongated member 6 for preventing such presses 1 disposed in the apparatus 10 from falling out.

Such means 40 also includes adjusting the second bracket member 16 to a smaller width than the first bracket member 12 whereby such press is too wide to pass completely through the apparatus 10 and is thereby retained.

While a presently preferred embodiment and alternate embodiments of the present invention have been described in detail above, it should be understood that various other adaptations and/or modifications of the invention can be made by those persons who are particularly skilled in the art without departing from either the spirit of the invention or the scope of the appended claims.

I claim:

1. An apparatus for storing various types of presses, said apparatus comprising:
(a) a first elongated frame member having each of a first predetermined shape and a first predetermined length and formed of a first predetermined material, said first predetermined shape of said first frame member includes a C shape;
(b) a second elongated frame member having each of a second predetermined shape and a second predetermined length and formed of a second predetermined material, said second predetermined shape of said second frame member includes a reverse C shape,
(c) at least one bracket member, one end of said at least one bracket member engageable with and secured to a bottom portion of said first elongated frame member and a second end of said bracket member engageable with and secured to a bottom portion of said second elongated frame member, said at least one bracket member having a slot formed therethrough for adjustably connecting said second elongated frame member with said first elongated frame member;
(d) a first securing means for securing said first member to one end of said at least one bracket member and said second frame member to a radially opposed end of said at least one bracket member; and
(e) a second securing means for securing said apparatus to one of a wall member, an inside of a door, an underside of a cabinet and an underside of a counter top.

2. The apparatus, according to claim 1, wherein said first securing means for securing said first frame member and said second frame member to said at least one bracket member includes nuts and bolts and/or an adhesive material.

3. The apparatus, according to claim 1, wherein said apparatus includes two bracket members, a first one of said two bracket members being disposed between a first end and a second end of each of said first elongated frame member and said second elongated frame member and a second one of said two bracket members being disposed between said first one of said two bracket members and said second end of each of said first elongated frame member and said second elongated frame member.

4. The apparatus, according to claim 3, wherein a distance between said first elongated frame member and said second elongated frame member is adjustable so as to fit different sizes of such various types of presses.

5. The apparatus, according to claim 1, wherein such presses are secured between said first elongated frame member and said second elongated frame member, edges of such presses are engageable with said C-shape of said first elongated frame member and said reverse C-shape of said second elongated frame member.

6. The apparatus, according to claim 1, wherein said second securing means for securing said apparatus with at least one of a wall member, an inside of a door, an underside of a cabinet and an underside of a counter top includes one of screws and an adhesive.

7. The apparatus, according to claim 6, wherein said second securing means is screws.

8. The apparatus, according to claim 1, wherein said apparatus includes a means for preventing such presses disposed in said apparatus from falling out.

9. The apparatus, according to claim 8, wherein said means for preventing such presses disposed in said apparatus from falling out includes a projection disposed on one of a back end and a bottom end of at least one of said first elongated member and said second elongated member.

10. The apparatus, according to claim 8, wherein said means for preventing such presses disposed in said apparatus from falling out includes adjusting said second bracket member to a smaller width than said first bracket member whereby such press is too wide to pass completely through said apparatus and is thereby retained.

11. The apparatus, according to claim 1, wherein said first and said second predetermined material are similar.

12. The apparatus, according to claim 11 wherein said first and said second predetermined material is one of metal and plastic.

13. The apparatus, according to claim 12, wherein said predetermined material is metal.
